(19) United States
(12) Patent Application Publication
(10) Pub. No.: US 2024/0420163 A1
(43) Pub. Date: Dec. 19, 2024

(54) ENTITY ENGAGEMENT

(71) Applicant: DevRev, Inc., Palo Alto, CA (US)

(72) Inventors: Dheeraj Pandey, San Jose, CA (US); Manoj Agarwal, Palo Alto, CA (US); Chandra Nath, Los Altos, CA (US); Mohan Maturi, San Jose, CA (US); Nikhil Kumar, San Jose, CA (US); Shruthi Racha, Redwood City, CA (US); Shamel Sameer, Rosenberg, TX (US); Trisha Maturi, San Jose, CA (US)

(73) Assignee: DevRev, Inc., Palo Alto, CA (US)

(21) Appl. No.: 18/739,585

(22) Filed: Jun. 11, 2024

Related U.S. Application Data
(60) Provisional application No. 63/521,619, filed on Jun. 16, 2023.

(51) Int. Cl. G06Q 30/0201

(52) U.S. Cl. CPC G06Q 30/0201

(57) ABSTRACT

Techniques for entity engagement are disclosed. An onboarding request is received from an interested entity and a first profile is generated for the interested entity. The onboarding of interested entity is verified and upon successful verification, the first profile is stored in an immutable form on a decentralized authentication framework. Further, an engagement request is received, from at least one of the interested entity and the entity of interest, to initiate a profile engagement between the interested entity and the entity of interest. The engagement request is authenticated to determine the credibility of the engagement request. Upon successful authentication of the engagement request, the first profile and the second profile is retrieved from the decentralized authentication framework. Based on an approval received from at least one of the interested entity and the entity of interest, engagement is initiated between the interested entity and the entity of interest.

### CROSS-REFERENCE TO RELATED APPLICATIONS

The present application claims the benefit of priority to U.S. Provisional Application No. 63/521,619, which is hereby incorporated by reference in its entirety.

### TECHNICAL FIELD

The subject matter described herein, in general, relates to entity engagement, and in particular to, entity engagement for facilitating engagement of profiles of entities.

### BACKGROUND

Products and services of an organization are deployed in a connected environment having numerous devices that communicate with each other. The devices communicating in the connected environment may range from developer-end devices for development of products or services to user-end devices for operating the deployed product and services. For example, a connected environment for an organization that develops a software product may inhabit a development ecosystem and a user ecosystem. In addition to the devices in direct engagement with the development, management, and operation of the product and services, there may also be entities who seek interest in the products but do not directly engage with the products and services. The entities seeking interest may be located outside the connected environment and may be interested in the activities of the organization and may thus seek to be in an indirect engagement with the organization.

### BRIEF DESCRIPTION OF DRAWINGS

A detailed description is provided with reference to the accompanying figures. In the figures, the left-most digit(s) of a reference number identifies the figure in which the reference number first appears. The same numbers are used throughout the drawings to reference features and components.

FIG. 1 illustrates a communication network implementing an entity engagement system, in accordance with an example of the present subject matter.

FIG. 2 illustrates schematic components of the entity engagement system, according to an example implementation of the present subject matter.

FIG. 3 illustrates a method of entity engagement, according to an example implementation of the present subject matter.

FIG. 4 illustrates a non-transitory computer-readable medium for facilitating entity engagement, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

Products and services operating in a connected environment may interact with entities operating internally to the connected environment and externally to the connected environment. Certain external entities may have a sterling interest in the connected environment and may hold significant importance for the smooth operation and maintenance of the products and services. As a result, an interested entity may be willing to seek engagement with an entity of interest and vice versa, the entities of interest may seek engagement with the interested entity. The entities of interest may include organizations owning or maintaining the products and services in the connected environment. In the same vein, the interested entities may seek engagements with the entities of interest based on a profile of the entity of interest. In an example, the profile of the entity of interest may elucidate characteristics of the product or service for which the engagement may be requested. Further, the entities of interest may seek engagements from the interested entity based on a profile of the interested entity. In an example, the profile of the interested entity may include characteristics determining trustworthiness of the interested entity.

Therefore, the process of searching and identifying interested entities and convincing them for engagement is a cumbersome process for the entities of interest and the entities of interest have to remain cautious while seeking engagement. Moreover, understanding the engagement ecosystem and convincing the interested entities to engage becomes more difficult since the operators of the entities of interest work in the field of either product development or providing services lack the skills and knowledge of creating engagements.

Similarly, the process of identifying the entities of interest that are engagement-worthy is also difficult on the part of an interested entities. An interested entity may be approached by several entities of interest that may seek engagement. However, selecting the most viable entity of interest for engagement requires thorough analysis of a profile of the entity of interest, in terms of gaining knowledge and performance metrics of the product and/or services offered by the entity of interest, to predict an effectiveness of the engagement.

Also, interested entities and entities of interest may lack trust amongst each other due to lack of transparency in the engagement process. For instance, the entities of interest and/or the entities may omit material facts in their profile or may provide fraudulent information, such as, information on previous engagements, performance of previous engagements, existing liabilities, current engagements, that may be deterrent to the cause for engagement. Similarly, the entities may exploit the vulnerability of the entities of interest in need of the engagement, and/or the lack of engagement capabilities of the principals of the organizations.

The existing ecosystem is also facilitated by third parties, commonly referred to as brokers. The entities of interest and the interested entities connect with such brokers who manage the process of engagements and allow introduction between the entities of interest and the interested entities. Therefore, engagements are also many a times dependent on the competency and reliability of the brokers involved in the process.

However, reaching out to the brokers may not be easy, and may be constrained by various factors, such as trust, location, and the like. For example, some entities of interest may not be comfortable with sharing private and privileged information with such brokers, as there remains an apprehension about the reliability of the third parties acting as brokers. Similarly, interested entities may also not completely trust the information provided by the brokers about the entities of interest.

The brokers also charge a service fee for facilitating the engagement process. This service fee is generally high, and therefore the brokers are keenly interested in completing a successful engagement. Such an interest in completing the engagement may however be detrimental to the interests of the actual entities involved in the process, and to the authenticity of the engagement. The entities may be at least one of the interested entities and/or the entities of interest. Certain interested entities may not be able to fully understand the nuances of the engagement considerations, and brokers with malafide intent may take advantage of the same. Further, the implications of any incompetence and negligence on behalf of the broker has to be borne by the entities. Accordingly, enabling the engagement process via the brokers also sometimes lacks security.

Even if mediation from the brokers is avoided, the complexities associated with engagement requirements would have to be endured by the entities themselves. Particularly, those entities of interest which have strong networks may be able to gain access to early-stage engagements. That is, principal members of the engagement must establish strong relationships with interested entities to secure engagements. Although few forums exist that facilitate the engagement process, they charge asymmetric fees for facilitating engagement for the entities registered on their platform.

Therefore, the existing engagement ecosystem lacks a comprehensive, secure and transparent mechanism for facilitating a link between the interested entities and entities of interest. The entities of interest have to spend more time worrying about the different aspects of the engagements with external entities than about the operation and performance of the products and/or services. Further, the entities of interest remain worried about performance, transparency, and information management.

The present subject matter relates to entity engagement for facilitating engagement by integration of interested entities and entities of interest into a single platform. The entity engagement is implemented without the intervention of any broker and allows the entities of interest and the interested entities to connect directly. The entity engagement is implemented using blockchain technology which allows seamless onboarding of the interested entities and the entities of interest, hereinafter collectively referred to as entities, and securely and immutably stores data relevant to different entities. Relevant profile information of the entities in one or more repositories implemented using a decentralized authentication framework. The decentralized authentication framework may be implemented in blockchain-based platforms such as (but not limited thereto), Ethereum, Hyperledger Fabric, R3 Corda, Tezos, Stellar, and ConsenSys Quorum. The relevant data may include, for example, information related to the engagements that occur between the entities, data related to transfer of assets, if any, as a result of the engagement, data related to accreditation, transfer of tokens, and the like. The data undergoes a hashing process and is stored in the form of multiple blocks connected with each other in decentralized authentication framework. These blocks are sequentially secured, and any modification to a hash-secured block is verified using peer-to-peer consensus in the decentralized authentication framework. Common consensus mechanisms include proof of work (PoW), proof of stake (PoS), and delegated proof of stake (DPoS), among others. Each block in the network maintains a copy of the ledger to ensure redundancy and fault tolerance and are linked together in a chronological chain using cryptographic hashes.

A block typically contains a list of transactions, a timestamp, a reference to the previous block in the chain (often in the form of a cryptographic hash of the previous block's contents), and a nonce, which is a number used once to help ensure the security of the decentralized authentication framework. The process of adding a new block to the authentication framework may involve solving a computationally difficult problem to discover a nonce that produces a hash with specific properties. Once a block is added to the chain, the transactions contained within it are considered confirmed and are virtually immutable. The implementation of the functionalities of decentralized authentication framework makes the stored data immutable, thereby enhancing the security and trustworthiness of the system.

Further, since records of each modification in the data of the entity engagement is immutably stored in the decentralized authentication framework and is accessible by all entities of the entity engagement, transparency is ensured in the engagement process. In an example, the entity engagement allows engagements between the entities to occur by initiating a transfer of tokens in exchange of transfer of assets. Multiple smart contracts may be created and stored in the decentralized authentication framework to implement engagements at various levels. Smart contracts may be a pre-defined set of rules created by an administrator of the entity engagement, that controls the implementation of the engagement process. The available smart contracts may be executed autonomously by the entity engagement to perform steps involved in the engagement process. The self-executing nature of the smart contracts ensures that the engagements on the decentralized authentication framework occur in a pre-defined manner, and no tampering or malpractices occur during the engagement process, thereby providing reliability to the entity engagement.

In accordance with the present subject matter, an interested entity or an entity of interest may request onboarding for entity engagement whereby the entities may provide the information regarding their portfolio for being stored as a profile. In one example, the entities of interest may provide information related to the product or service for which they seek engagements. In another example, the entities of interest may provide information on the tokens they possess to initiate a transfer of assets, in order to determine their engagement capabilities. Based on receipt of the onboarding request, it may be determined that the interested entity intends to create an engagement with an entity of interest. Therefore, a first profile may be generated for the interested entity. The profile may include the information as a first plurality of attributes and a first plurality of attribute values associated with each of the first plurality of attributes. To identify the first profile and the first interested entity, for example to perform create, read, update, delete (CRUD) activities on the first profile, the first profile may be associated with a first unique identifier.

Post on-boarding of the entities, the information provided by the entities is subjected to a verification process to ensure the veracity of the onboarding of the interested entity. For example, the first profile may be verified for verifying the onboarding of the interested entity. The veracity of the onboarding of the interested entity may be verified by executing pre-defined veracity test sequences associated with at least a subset of the first plurality of attributes of the first plurality of attribute values. For example, the veracity test sequences may include parsing one or more certifications of trustworthiness provided by the entities to be scrutinized against pre-defined parameters for veracity. In another example, the veracity test sequence may include analyzing historical data associated with the entity to provide a confidence score to an attribute of a subset of the first plurality of attributes of the first profile. The confidence score may indicate a probability of accuracy based on, for example, historical recurrences of the attribute. The attribute may be verified when the confidence score is above a pre-defined confidence score threshold value. The pre-defined confidence score threshold value may be a preset value defining a minimum score that must be obtained, for example, as a result of analysis historical data, for the attribute to be successfully verified for the entity.

The verified first profile may be stored in decentralized authentication framework for future reference by one or more entities. By storing the information in the decentralized authentication framework, verified information is made immutable and tamper-free, for reasons explained above, thereby ascertaining, and maintaining its credibility. Therefore, the bottleneck associated with several rounds of information transfer for verification may be avoided.

In an example implementation of the present subject matter, the on-boarded entities may be linked with a first unique token repository for enabling a transfer of tokens in exchange of a plurality of assets in the engagement. Each token may be assigned to a pre-defined token value. In an example, the on-board entities may import a pre-assigned token repository, that may be available with the entities, from a different decentralized authentication framework. In another example, the first unique token repository may be created after on-boarding and may be linked to the entity.

In operation, each entity may be associated with a state that may determine a point in the smart contract which needs to be executed for implementation of the engagement. In one example, the state may indicate whether an engagement request has been raised by the entity. The request for engagement may either be a request made by the interest entity or by an entity of interest. Upon detecting such a request, the engagement request may be authenticated for determining its credibility. The engagement request may be authenticated by authenticating the at least one of the interested entity and the entity of interest. In an example, the authentication may be based on the verified information stored in the decentralized authentication framework. Similar to the interested entity, the entity of interest may include a second profile associated thereto on the decentralized authentication framework. The second profile includes a second plurality of attributes, a second plurality of attribute values associated with each of the second plurality of attributes, and a second unique identifier associated with the second profile to identify the entity of interest.

Upon successful authentication of the engagement request, the first profile and the second profile may be retrieved from the decentralized authentication framework. At least one of the entities may approve initiation of engagement between the interested entity and the entity of interest. In an example, the entities may provide the approval upon review of the trustworthy and tamper free profiles obtained from the decentralized authentication framework.

In an example, a verified engagement request may include an engagement activity involving initiating a transfer of tokens between the first unique token repository and a second token repository associated with the entities of interest and the interested entities, respectively. In an example implementation, each unit token may be assigned a predefined value, and may be exchanged between the entities in engagement, to initiate a transfer of assets.

Therefore, the time-consuming and the complex steps of the engagement process are eliminated by enhancing the transparency and the security of the entire process. This approach not just fortifies the security of sensitive data but also facilitates real-time verification of entity profiles and engagement histories, which is instrumental in establishing and maintaining trust between entities. Moreover, the implementation of smart contracts automates the engagement process, enforcing the terms of engagement in a transparent and self-executing manner. This automation not only reduces the potential for human error but also ensures adherence to regulatory compliance. Being governed by smart contracts, the entity engagement may dynamically adapt to various regulatory frameworks, providing a flexible yet secure platform for entities to engage with each other. Additionally, the technical architecture allows for scalability and interoperability across different networks and services, further enhancing its utility and applicability in a global connected environment. These benefits collectively contribute to a more efficient, secure, and reliable entity engagement process.

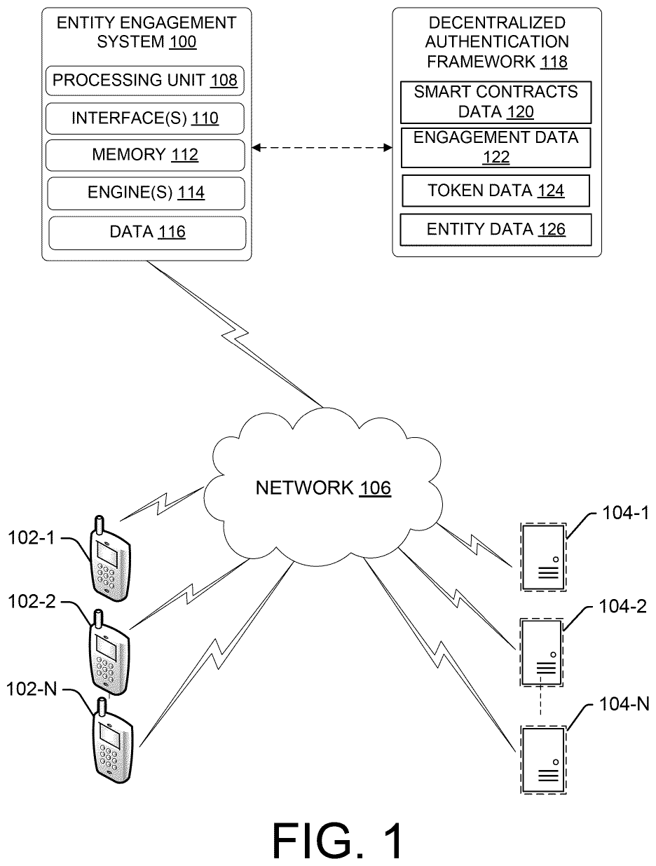

The present subject matter is further described with reference to FIGS. 1-3. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a communication network implementing an entity engagement system 100, in accordance with an example of the present subject matter. The entity engagement system 100 may either be a standalone computing system or a combination of multiple computing devices operating together in a distributed computing environment. In an example, the entity engagement system 100, among other functions, may facilitate the engagement process.

The entity engagement system 100 may be connected to multiple interested entities 102-1, 102-2, . . . , 102-N, and entities of interest 104-1, 104-2, . . . , 104-N, through a network 106. The entity engagement system 100 may be communicatively coupled to computing devices (not shown) associated with each of the interested entities 102-1, 102-2, . . . , 102-n, and the entities of interest 104-1, 104-2, . . . , 104-N either through a direct communication link, or through multiple communication links of the network 106. Examples of the computing devices through which the interested entities 102-1, 102-2, . . . , 102-N and entities of interest 104-1, 104-2, . . . , 104-N, may communicate with the re entity engagement system 100 may include, but are not limited to, smartphones, laptops, desktops, televisions, and personal digital assistants (PDAs).

The network 106 may be a wireless or a wired network, or a combination thereof. The network 106 can be a collection of individual networks, interconnected with each other and functioning as a single large network. Examples of such individual networks include, but are not limited to, Global System for Mobile communication (GSM) network, Universal Mobile Telecommunications System (UMTS) network, Long Term Evolution (LTE) network, personal communications service (PCS) network, Time-division multiple access (TDMA) network, Code-Division Multiple Access (CDMA) network, next-generation network (NGN), public switched telephone network (PSTN), and Integrated Services Digital Network (ISDN). Depending on the terminology, the network includes various network entities, such as gateways and routers; however, such details have been omitted to maintain the brevity of the description.

In an example implementation of the present subject matter, the interested entities 102-1, 102-2, . . . 102-N and the entities of interest 104-1, 104-2, . . . 104-N, may be on-boarded onto the entity engagement system 100. For the ease of reference, hereinafter, the interested entities 102-1, 102-2, . . . 102-N have been referred to as an interested entity 102, and the entities of interest 104-1, 104-2, . . . 104-N have been referred to as an entity of interest 104. Further, the interested entity 102 and the entity of interest 104 have hereinafter been collectively referred to as entities.

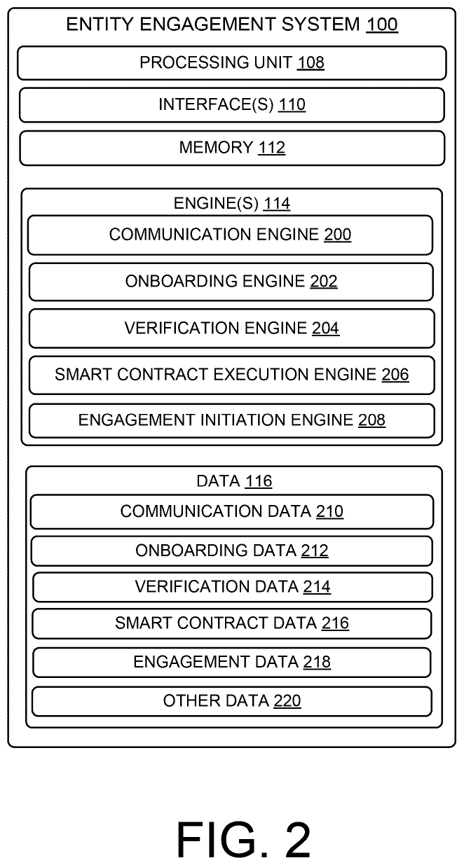

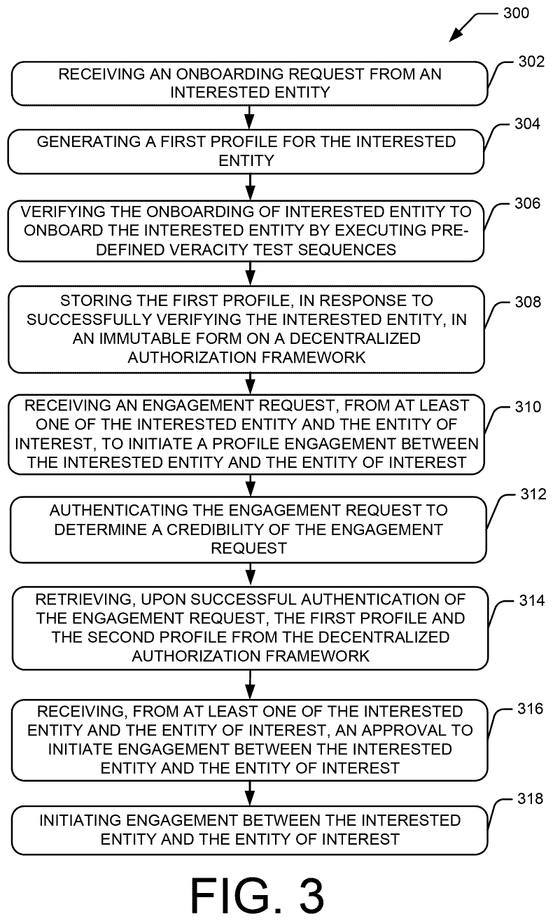

The entity engagement system 100 may receive data relevant to the engagement process from the interested entities 102 and the entities of interest 104 over the network 106. The data may include, for example, identification data, engagement terms data, login data, token repository data, and token data. The entity engagement system 100 may perform the on-boarding process to securely register the interested entities 102 and the entities of interest 104 interested in engagement. Upon on-boarding, the entity engagement system 100 allows the interested entities 102 and entities of interest 104 to be associated with a token repository to allow executing an engagement activity. Examples of the engagement activity may include, but are not limited to, transfer of assets, exchange of tokens associated with a predefined token value, sending tokens, creating records, and registering or receiving requests. A detailed explanation of implementation of the on-boarding process and facilitation of entity engagement is further provided with reference to explanation of examples in FIGS. 2 and 3.

In an example, the entity engagement system 100 includes a processing unit 108 to run at least one operating system and other applications and services. The entity engagement system 100 further includes a memory 112, interface(s) 110, one or more engines 114, and data 116.

The processing unit 108, amongst other capabilities, may be configured to fetch and execute computer-readable instructions stored in the memory. The processing unit 108 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine readable instructions.

When provided by a processing unit 108, the functions may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included. The processing unit 108 may include routines, programs, objects, components, data structures, and the like, which perform particular tasks or implement particular abstract data types. The processing unit 108 may further include modules that supplement applications on the entity engagement system 100, for example, modules of an operating system. Further, the processing unit 108 may be implemented in hardware, instructions executed by a processing unit, or by a combination thereof.

The interface(s) 110 may include a variety of machine-readable instructions-based interfaces and hardware interfaces that allow the entity engagement system 100 to interact with different components, such as the processing unit 108, the memory 112, the engines 114, and the data 116. Further, the interface(s) may enable the entity engagement system 100 to communicate with computing devices, for example, the computing devices through which the interested entities 102 and entities of interest 104 communicate with the entity engagement system 100, web servers, and external repositories. The interface(s) may facilitate multiple communications within a wide variety of networks and protocol types, including wireless networks, wireless Local Area Network (WLAN), RAN, satellite-based network, and the like.

The memory 112 may be coupled to the processing unit 108 and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 112 may store the information received and in possession of the entity engagement system 100 as data 116.

In an implementation, the engine(s) 114 may be machine-readable instructions which, when executed by the processor, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The entity engagement system 100 is communicably coupled with a decentralized authentication framework 118 via one or more interface(s) 110. The decentralized authentication framework 118 stores information received from the entity engagement system 100 in a reliable and immutable form. The decentralized authentication framework 118 may include smart contracts data 120, engagement data 122, token data 124, and entity data 126.

In one example implementation, an administrator of the entity engagement system 100 may create one or more smart contracts and may deploy the same on the decentralized authentication framework 118. The smart contracts may be stored in the decentralized authentication framework 118 as smart contracts data 120. A smart contract is a self-executing piece of code which is executed upon initiation of an engagement activity based on a request received on the entity engagement system 100. When an engagement activity is initiated on the entity engagement system 100, the entity engagement system 100 identifies a state associated with the interested entity 102 and/or the entity of interest 104, and initiates execution of the smart contract based on the identified state. In an example, an onboarding request may be received by the entity engagement system 100 from an interested entity 102. In the example, the state associated with the interested entity 102 may be identified as an onboarding state and an engagement activity related to onboarding may be triggered.

To accomplish the onboarding, a smart contract may be executed to generate a first profile for the interested entity 102. The first profile for the interested entity 102 may be generated based on information related to the interested entity 102 either automatically or in response to prompts issued by the entity engagement system 100 to the interested entity 102. The first profile may include a first plurality of attributes, a first plurality of attribute values associated with each of the first plurality of attributes. For example, the varied information related to the interested entity 102 may and categorized into a first plurality of attributes and may be stored accordingly. The onboarding of the interested entity 102 may be verified by executing a pre-defined veracity test sequences associated with at least a subset of the first plurality of attributes of the first plurality of attribute values to verify the first profile. Upon verification, the verified first profile, the first plurality of attributes, and the first plurality of attribute values associated with each of the first plurality of attributes may be stored immutably in the decentralized authentication framework 118 as profile data 122. The first profile may be associated with a first unique identifier to identify the interested entity 102 to which the first profile belongs. While the onboarding has been explained in relation to receiving an onboarding request from the entity of interest, the same shall not be construed as a limitation, and the onboarding request may also be received from the entity of interest 104.

Further, the records of the engagement activities performed on entity engagement system 100 are automatically sent by the entity engagement system 100 for storage in the decentralized authentication framework 118 as engagement data 122.

In one example, the entity engagement system 100 may automatically create a unique token repository on the decentralized authentication framework 118 for an interested entity 102 and/or entity of interest 104 that may be on-boarded. In another example, the entity engagement system 100 may receive an indication of an already existing unique token repository on the decentralized authentication framework 118 for an interested entity 102 and/or entity of interest 104 that may be on-boarded, and the entity engagement system 100 may link the already existing unique token repository with the interested entity 102 and/or entity of interest 104.

For example, the first profile of the interested entity 102 stored as profile data 122 may be linked with a first unique token repository. The unique token repository may maintain one or more tokens and each of the one or more tokens have assigned thereto a pre-defined token value. The information regarding the unique token repository and the tokens maintained in the unique token repository may be stored in the immutable form on the decentralized authentication framework 118 so that valid and secure engagement may be performed. The performing of engagements may be realized with transfer of a number of tokens assigned to a pre-defined token value. The pre-defined token value may be associated with each engagement activity and a record of the pre-defined token value for the each engagement activity may be stored as a lookup table on the decentralized authentication framework 118. In another example, the pre-defined token value for the engagement may be prescribed by and agreed upon by at least one of the interested entity 102 and the entity of interest 104. In one example, the token repository may register events and update the state pertaining to the interested entity 102 and/or entity of interest 104.

In an example implementation of the present subject matter, once a request for engagement from an interested entity 102 is approved, one or more tokens, representative of the assigned token value for engagement, may be transferred from the token repository of the interested entity 102 to the token repository of the entity of interest 104. The information related to the tokens associated with each token repository is stored in the decentralized authentication framework 118 as token data 124. Further, the data associated with each interested entity 102 and the entity of interest 104, may be stored in the decentralized authentication framework 118 as entity data 126. The entity data 126 may include the information related to the login credentials, information related to certifications and accreditations, information related to the ownership of assets, engagement histories, and the like. Further details related to the implementation of the entity engagement system 100 are provided with reference to FIG. 2.

FIG. 2 illustrates schematics of the entity engagement system 100, in accordance with an example of the present subject matter. As already described, the entity engagement system 100 may be communicatively coupled to interested entities 102 and entities of interest 104 over the network 106. Further, as already described, the entity engagement system 100 is also communicably coupled with the decentralized authentication framework 118 via one or more programmatic interfaces.

The entity engagement system 100 may include a processing unit 108 and a memory 112 coupled to the processing unit 108. The entity engagement system 100 may further include one or more interface(s) 110 to enable communications with different components of the entity engagement system 100. The entity engagement system 100 may further include engine(s) 114, where the engine(s) 114 may include a communication engine 200, an onboarding engine 202, a verification engine 204, a smart contract execution engine 206, and an engagement initiation engine 208 coupled with each other. The engine(s) 114 may store the information from the communication engine 200, an onboarding engine 202, a verification engine 204, a smart contract execution engine 206, and an engagement initiation engine 208 as communication data 210, onboarding data 212, verification data 214, smart contract data 216, and engagement data 218 in the memory 112.

In an example implementation, the entity engagement system 100 may receive an on-boarding request from an interested entity 102 or an entity of interest 104. The receiving of the on-boarding request may be enabled by the communication engine 200 of the entity engagement system 100. The communication engine 200 may identify a state of the request as being an onboarding request and may transmit the request for processing to the onboarding engine 202. In an example, the on-boarding request may include information related to the credentials of the requestor. The requestor may be any one of the interested entity 102 or an entity of interest 104. In another example, the on-boarding request may be accompanied by personal information related to the interested entity 102 or the entity of interest 104. The personal information may include data that may be relevant to the engagement process.

In one example implementation, where the on-boarding entity is an entity of interest 104, the personal information may include the profile of the entity of interest 104, which may include data related to products or services developed by the entity of interest 104 with which engagement is to be executed. The personal information may also include data related to other fields in which the entity of interest primarily deals in. In an example, the personal information may include records related to previous engagements of the entity of interest 104. Personal information related to an entity of interest 104 may be utilized in conducting the due diligence of the entity of interest 104, by the interested entity 102, or a third party.

Furthermore, in another example implementation of the entity engagement system 100 where the on-boarding entity is an interested entity 102, the personal information related to the interested entity 102 may include information that may be referred to determine the trustworthiness of the interested entity 102. In another example, the personal information related to the interested entity 102 may include information related to history of engagements made by the interested entity 102. In yet another example, the personal information related to the interested entity 102 may include the assets the entity of interest 104 with which the interested entity 102 wishes to engage.

The entity engagement system 100 may create a unique identifier for the interested entity 102 and/or entity of interest 104 that has sent the request, as a part of the on-boarding process. The on-boarding process may be enabled by the on-boarding engine 202. The entity engagement system 100 may send the unique identifier, via the communication engine 200 to the decentralized authentication framework 118 (not shown) for storage.

The entity engagement system 100 may further verify the onboarding of the onboarding entity by verifying the information provided by the interested entities 102 and/or the entities of interest 104. The verification of information may be enabled by the verification engine 204. The entity engagement system 100 may receive the personal information related to the interested entity 102 and that of the entity of interest 104 and may conduct a verification process to ensure the integrity of the provided information. The verification engine 204 may be configured to execute pre-defined veracity test sequences to verify at least a subset of the plurality of attributes. The verification of the subset of the plurality of attributes may verify the profile of the onboarding entity.

In one example, the verification process may include an analysis of the history of previous round of engagement to determine an accuracy of an attribute of the profile of the at least one of the interested entity 102 and the entity of interest 104. The verification engine 204 may analyze historical data associated with the interested entity to provide a confidence score to an attribute. The verification engine 204 may compare the confidence score of the attribute with a pre-defined confidence score threshold value. If the verification engine 204 identifies the confidence score to be greater than the pre-defined confidence score, the verification engine 204 may transmit an alert to the onboarding engine 202 that the attribute is verified. In the example, where a first profile is generated for the interested entity 102, the attribute may be a subset of the first plurality of values of the first profile. In another example, the personal information related to an interested entity 102 may be sent to an authorized third-party accreditation service provider by the verification engine 204, for accreditation of the interested entity 102. In yet another example, the certifications of validation provided by the interested entities 102 and the entities of interest 104 may be scrutinized against pre-defined parameters for veracity. For scrutiny of the certifications, the entity engagement system 100 may parse the one or more certifications against pre-defined parameters for veracity. Upon successful verification of the subset of the plurality of attributes, the profile of the onboarding entity may be considered verified. In response, the verification engine 204 may transmit an alert to the onboarding engine 202 that the profile of the onboarding entity is verified. The onboarding entity may be one of the interested entity 102 and the entity of interest 104.

In response to receiving the alert from the verification engine 204 that the onboarding entity is verified, the onboarding engine 202 may store the verified profile in an immutable form on a decentralized authentication framework. The decentralized authentication framework may be decentralized authentication framework 118 shown in FIG. 1.

The entity engagement system 100 is further configured to link a unique token repository to the profile of an on-boarding entity and store the information of the unique token repository at the decentralized authentication framework 118. The unique token repository may be utilized to register events and update the state of the on-boarding entity, in the course of engagement with the entity engagement system 100. The unique token repository may maintain one or more tokens and each of the one or more tokens have assigned thereto a pre-defined token value.

Further, the entity engagement system 100 identifies if the on-boarding entity has a token repository stored in a decentralized authentication framework that may be globally accessible. The existing token repository of the on-boarding entity may be imported by the entity engagement system 100, for carrying out engagement activities. The imported token repository may be associated with the unique identifier provided to the on-boarding entity, by the entity engagement system 100, to carry out the engagement activities. In another example implementation of the present subject matter, the entity engagement system 100 may create a new token repository for the on-boarding entity. The creation of the new token repository may be enabled by the on-boarding engine 202. The entity engagement system 100 may send a request, via the communication engine 200, to the decentralized authentication framework 118 to store the new token repository. Further, the on-boarding engine 202 may send a request, via the communication engine 200, to store an association between the newly created token repository and the unique identifier of the on-boarding entity in the decentralized authentication framework 118.

The entity engagement system 100 further identifies whether there are a pre-defined number of tokens available in the token repository assigned to the interested entity 102 and/or the entity of interest 104. If not, tokens may be added to the token repository associated with the interested entity 102 and/or the entities of interest 104 such that the number of tokens credited may be equivalent to the difference between a predefined number of tokens and the actual number of tokens available in the token wallet. The addition of tokens may be enabled by the on-boarding engine 202 and/or the engagement initiation engine 208, depending upon the state at which a deficiency in the number of tokens in the token repository is identified.

From different on-boarded entities, the entity engagement system 100 may receive an engagement request. In one example implementation, the request may be sent by an interested entity 102 to communicate an intent to engage in an entity of interest 104. An instance of the received request may, in one example, be stored in the form of other data 220 in the memory 112 of the entity engagement system 100. The engagement request stored in the other data 220 may be authenticated to determine a credibility of the engagement request. The authentication may be performed by an authentication of the at least one of the interested entity 102 and the entity of interest 104 raising the request. The at least one of the interested entity 102 and the entity of interest 104 raising the request may in an example be authenticated by validation of private credentials.

Further, the entity engagement system 100 may further enable sending a notification of the received intent to engage, via the communication engine 200, to the entity of interest 104 with which the engagement is intended. The entity of interest 104 may include a second profile associated thereto on the decentralized authentication framework 118. Similar to the interested entity 102, the second profile belonging to the entity of interest 104 may include a second plurality of attributes, a second plurality of attribute values associated with each of the second plurality of attributes, and a second unique identifier associated with the second profile to identify the entity of interest 104. A successful authentication of the engagement request may be succeeded by retrieving the profile of the interested entity 102 and the entity of interest 104 for review by each other.

Further, the entity engagement system 100 may receive an approval for initiating engagement between the interested entity 102 and the entity of interest 104 from at least one of the interested entity 102 and the entity of interest 104. In one example, the approval may be received by the entity of interest 104 when a request for engagement is raised by the interested entity 102. In another example, the approval may be provided by an administrator of the entity engagement system 100. The administrator of the entity engagement system 100 may approve the initiation of engagement based on a prior-received confirmation from the entity of interest 104 to approve engagements on their behalf.

Upon receiving an approval of the engagement, the entity engagement system 100 may initiate the engagement between the interested entity 102 and the entity of interest 104. The engagement may be enabled utilizing the engagement initiation engine 208. The engagement initiation engine 208 may create and store an indication of an association of the interested entity 102 and the entity of interest 104, as engagement data 122, via the communication engine 200, in the decentralized authentication framework 118.

In an example, the engagement initiation engine 208 may establish, based on the approval, an association between at least a subset of the first plurality of attributes and a corresponding subset of the second plurality of attributes to create an engagement of the first profile and the second profile.

The engagement initiation engine 208 may initiate a transfer of tokens having a pre-defined token value from a first unique token repository to a second unique token repository. The first unique token repository may be associated with the unique identifier of an interested entity 102 and the second unique token repository may be associated with a unique identifier of an entity of interest 104 towards which the engagement is intended.

The transfer of tokens between the unique token repository of the interested entity 102 and the entity of interest 104, the engagement provides a proof of the engagement acceptance from the interested entity 102 and the entity of interest 104. Therefore, the entity engagement system 100 allows secure and reliable engagement between the interested entities 102 and the entities of interest 104. The engagement initiation engine 208 may further enable storing an indication of an associated of the interested entity 102 and the entity of interest 104 in the decentralized authentication framework 118, via the communication engine. The engagement initiation engine 208 may collect the data related to the transactions occurring in the entity engagement system 100, as engagement data 220. The engagement initiation engine 208 may further enable sending the collected data, via the communication engine 200, to the blockchain repository. Therefore, the engagement data 220 can be stored immutably in the decentralized authentication framework 118 and remains tamper-proof. The engagement data 220 may be updated in a record of engagements at the decentralized authentication framework 118 for the at least one of the interested entity and the entity of interest. The engagement data 220 may be appended with at least one of the first unique identifier assigned to the interested entity 102 and the second unique identifier assigned to the entity of interest 104. The unique identifier may ease finding the record of engagements associated with the interested entity 102 and the entity of interest 104 at the decentralized authentication framework 118.

To enable the engagements occurring on the entity engagement system 100, one or more smart contracts may be received from the decentralized authentication framework 118. A state of the interested entity 102 and the entity of interest 104 may be identified by the entity engagement system 100. Based on the identified state, one or more smart contracts may be retrieved, via the communication engine 200, from the decentralized authentication framework 118. The retrieved smart contracts may be executed from a portion defining the state of requesting the engagement. The execution of the smart contracts may be enabled by the smart contract execution engine 206. The retrieved smart contract governs the operation of the entity engagement system 100. The operations may include, but are not limited to, profile generation, engagement initiation, and information dissemination. Each smart contract may include defined members and Application Programming Interface (API) functions, configured by an administrator of the entity engagement system 100. The contracts interact with each other via these APIs to modify the member values, and progress the engagement.

An administrator may configure a main contract for the lifetime of the operation of the entity engagement system 100. The main contract defines the entire underlying operation functionality of the entity engagement system 100. For each engagement request, a new smart contract may be created. Further, a contract may be created for each interested entity 102 and the entity of interest 104 onboarded with the entity engagement system 100. Main contract has pointers to the contract based on the unique identifier of the interested entity 102 and the entity of interest 104.

The entity engagement system 100 may be configured to disseminate performance metrics for the engagement between the interested entity 102 and the entity of interest 104. The performance metrics may be certified using private keys associated with the decentralized authentication framework 118, at a predefined frequency. The performance metrics may be, but not limited to, Monthly Active Users (MAU), Daily Active Users (DAU), and Accounting Rate of Return (ARR). In an example, the performance metrics may be stored in the decentralized authentication framework 118. The performance metrics may be pulled by the entity engagement system 100 in real-time by the communication engine 200, and communicated to the at least one of the interested entity 102 and the entity of interest 104. In another example, engagement data 122 may be received from a record of engagement from the decentralized authentication framework 118, via the communication engine. The engagement data 122 may be analyzed by the engagement initiation engine 208 configured to determine performance metrics for the engagement between the interested entity 102 and the entity of interest 104. The performance metrics may be in the form of leading and lagging indicators for the entities and bridges the information gap among entities and strengthens trust between interested entities 102 and entities of interest 104. The access to the information related to the interested entities 102 and entities of interest 104 stored in decentralized authentication framework 118 combined with an overview of the performance analytics provides a comprehensive view of an entities' performance.

Therefore, the entity engagement system 100 digitizes and institutionalizes the entire engagement process.

FIG. 3 illustrates a method 300 for entity engagement, according to an example implementation of the present subject matter. The order in which the method 300 is described is not intended to be construed as a limitation, and any number of the described method blocks may be combined in any order to implement the method 300, or an alternative method. Furthermore, the method 300 may be implemented by processor(s) or computing device(s) through any suitable hardware, non-transitory machine-readable instructions, or a combination thereof.

It may be understood that steps of the method 300 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. The method 300 may be performed by components of the entity engagement system 100, such as the processing unit 108, interface(s) 110, memory 112, and engine(s) 114.

At step 302, an onboarding request is received from an interested entity. The on-boarding request may include on-boarding data, and may be indicative of an intention to create an engagement with an entity of interest. The interested entity may be authorized and logged into the entity engagement system based on auth0 and enabling social connections via auth0 integration. The on-boarding request may be received along with on-boarding data specific to the interested entity. The on-boarding data may include personal information associated with the interested entity that may be relevant to the purpose of engagement. In one example, the on-boarding data may include information that may be utilized in conducting due diligence on a profile of the interested entity. In another example, the on-boarding data may include the certifications and accreditations associated with the interested entity. In another example, the on-boarding data may include the type of activity for which the interested entity may wish to engage with the entity of interest.

At step 304, a first profile is generated for the interested entity. The first profile includes the onboarding information characterized into a first plurality of attributes. The onboarding information may thus be a first plurality of attribute values associated with each of the first plurality of attributes. Further, a first unique identifier may be associated with the first profile to identify the interested entity. The first unique identifier may be used to identify the interested entity for every activity undertaken at the entity engagement system 100. In one example, each activity conducted at the entity engagement system 100, may be recorded and stored against the unique identifier generated for the interested entity. The unique identifier may include, but not limited thereto, a username, an email address, a device identifier (MAC address, a serial number, and the like). In some example implementations, the unique identifier may be used in combination with a credential (for example, a personal identification number (PIN), a keyword, an answer to a challenge question, and the like). In an example, the unique identifier may have to be entered by the entity in combination with the credential, to initiate a transaction at the entity engagement system 100.

At step 306, the onboarding of the interested entity is verified by executing pre-defined veracity test sequences. The veracity test sequences may be associated with at least a subset of the first plurality of attributes of the first plurality of attribute values. In an example, the onboarding of the interested entity may be verified autonomously by the entity engagement system 100. For example, the veracity test sequences may include parsing one or more certifications of trustworthiness provided by the entities to be scrutinized against pre-defined parameters for veracity. In another example, the veracity test sequence may include analyzing historical data associated with the entity to provide a confidence score to an attribute of a subset of the first plurality of attributes of the first profile. The confidence score may indicate a probability of accuracy based on, for example, historical recurrences of the attribute. The attribute may be verified when the confidence score is above a pre-defined confidence score threshold value. The pre-defined confidence score threshold value may be a preset value defining a minimum score that must be obtained, for example, as a result of analysis historical data, for the attribute to be successfully verified for the entity. In another example, the onboarding of the interested entity may be verified by an authorized third party. For instance, the subset of the first plurality of attributes of the first plurality of attribute values may be sent to an authorized third party for accreditation. In another example, the subset of the first plurality of attributes of the first plurality of attribute values may be sent to an authorized third party for conducting due diligence.

At step 308, the first profile is stored in an immutable form on a decentralized authentication framework in response to successfully verifying the interested entity. The first profile may be communicated to the decentralized authentication framework. The decentralized authentication framework ensures that the first profile is stored in an immutable and tamper-proof manner. The first profile stored at the decentralized authentication framework may be accessible to all the entities on-boarded at the entity engagement system 100. Further, it is ensured that any unauthorized entity may not be able to make any alterations to the stored profiles. Ready access of the profiles to the entities allows an improved settlement, record keeping, tracking, and assurance. At the decentralized authentication framework, it is determined whether a token repository is available with the interested entity. The token repository maintains one or more tokens and each of the one or more tokens having assigned thereto a pre-defined token value. In one example, it may be determined that the interested entity already has an assigned token repository available on a decentralized authentication framework. In the example, the digital wallet may be imported and linked with to the first profile of the interested entity. In one example, the token repository may be identified based on an address of the token repository provided by the interested entity. In an example, the address may be provided by the interested entity in the form of on-boarding data received along with the request for on-boarding. The identified existing interested entity may be imported via an interface and associated with the first unique identifier generated for the interested entity at the entity engagement system 100. The imported token repository, upon associated with the first unique identifier, may be linked to the first profile as a first unique token repository. In an example, importing the token repository may be facilitated by installing and enabling metamask plugin in a web browser of an interested entity. In one example, the imported interested entity may be used for engagement activities by the interested entity identified by the unique identifier associated with the token repository at the entity engagement system 100. In another example, it may be determined that the interested entity does not have an assigned token repository available on the decentralized authentication framework. In the example, the first unique token repository may be created and linked to a first unique token repository to the first profile of the interested entity.

At step 310, an engagement request is received from at least one of the interested entity and the entity of interest to initiate a profile engagement between the interested entity and the entity of interest. In an example implementation, the request may be indicative of an intent of an interested entity and the entity of interest to engage. The interested entities may identify an engagement-worthy entity of interest from one or more entities of interest that may have been on-boarded with the entity engagement system 100. In an example, the interested entities may explore the immutable data stored at the decentralized authentication framework to identify entities of interest, with a profile that may be of interest to the interested entity. In such a scenario, the interested entity may send the engagement request. In another example, the request may include the nature of the engagement.

At step 312, the engagement request may be authenticated to determine a credibility of the engagement request. The engagement request may be authenticated by authenticating the at least one of the interested entity and the entity of interest. In an example, the authentication may be based on the verified information stored in the decentralized authentication framework. Similar to the interested entity, the entity of interest may include a second profile associated thereto on the decentralized authentication framework. The second profile includes a second plurality of attributes, a second plurality of attribute values, and a second unique identifier associated with the second profile to identify the entity of interest. The first profile and the second profile may be authenticated for determining credibility. In an example, the authentication may be based on a pre-defined set of rules, for example, defined in a smart contract stored on the decentralized authentication framework. In another example, the authentication may be based on rules defined by the at least one of the interested entity and the entity of interest.

At step 314, the first profile and the second profile are retrieved from the decentralized authentication framework upon successful authentication of the engagement request. The first profile and the second profile may be accessed by the interested entity and the entities of interest for careful consideration before proceeding with the engagement.

At step 316, an approval to initiate engagement between the interested entity and the entity of interest is received from at least one of the interested entity and the entity of interest. In one example implementation, the approval may be provided based on one or more parameters defined by the entity of interest towards which the engagement transaction is to be initiated. In such a scenario, the entity of interest and the interested entity may scrutinize the request to determine if they should take the engagement at the conditions associated with the received request.

At step 318, an engagement between the interested entity and the entity of interest is initiated. The initiating includes storing an indication of an association of the interested entity and the entity of interest in the decentralized authentication framework. In an example, initiating engagement between the interested entity and the entity of interest includes establishing, based on the approval, an association between at least a subset of the first plurality of attributes and a corresponding subset of the second plurality of attributes to create an engagement of the first profile and the second profile. Further, the initiating engagement between the interested entity and the entity of interest includes transferring a pre-defined token value from the first unique token repository to a second unique token repository, the second unique token repository being linked with the second profile and maintaining one or more tokens, each of the one or more tokens having assigned thereto a pre-defined token value. For instance, a required amount of tokens corresponding to the engagement activity is transferred from the token repository of the requestor of the engagement request. In the example implementation. The request may be indicative of an intent of an interested entity to engage with an entity of interest, a transfer of tokens may be initiated. In another example, initiating engagement between the interested entity and the entity of interest is performed by executing a smart contract associated with the engagement between the first profile and the second profile. The smart contract may be hosted on the decentralized authentication framework.

The method 300 may further include updating a record of the engagements for the at least one of the interested entity and the entity of interest. The record of engagements may be associated with the at least one of the first unique identifier and the second unique identifier. The record of engagements including information regarding historical engagements of the at least one of the interested entity and the entity of interest at the decentralized authentication framework. The record of engagements may be analyzed to determine performance analytics for the engagement between the interested entity and the entity of interest.

The entity engagement process discussed in method 300 provides the entities with uniform data access, periodic performance reporting, and token lifecycle management in a transparent, secure, and reliable manner.

It may be understood that steps of the method 300 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. The method 300 may be performed by components of the entity engagement system 100, such as the processing unit 108, interface(s) 110, memory 112, and engine(s) 114.

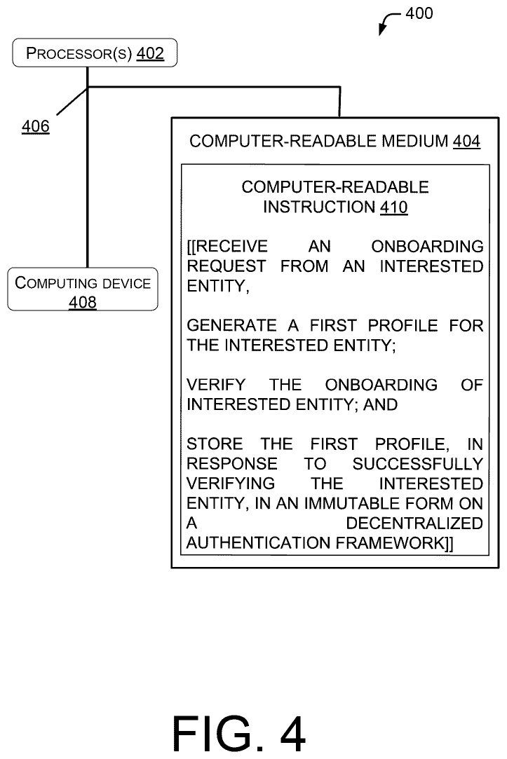

FIG. 4 illustrates a non-transitory computer-readable medium for facilitating entity engagement, in accordance with an example of the present subject matter.

In an example, the computing environment 400 includes a processor 402 communicatively coupled to a non-transitory computer readable medium 404 through communication link 406. In an example implementation, the computing environment 400 may be for example, the entity engagement system 100. In an example, the processor 402 may have one or more processing resources for fetching and executing computer-readable instructions from the non-transitory computer readable medium 404. The processor 402 and the non-transitory computer readable medium 404 may be implemented, for example, in the entity engagement system 100.

The non-transitory computer readable medium 404 may be, for example, an internal memory device or an external memory. In an example implementation, the communication link 406 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 404 includes a set of computer readable instructions 410 which may be accessed by the processor 402 through the communication link 406 and subsequently executed for facilitating communication in the connected environment. The processor(s) 402 and the non-transitory computer readable medium 404 may also be communicatively coupled to a computing device 408 over the network.

Referring to FIG. 4, in an example, the non-transitory computer readable medium 404 includes computer readable instructions 410 that when executed cause the processor 402 to receive an onboarding request from an interested entity. The onboarding request is indicative of an intention to create an engagement with an entity of interest.

The instructions 410, when executed, may further cause the processor 402 to generate a first profile for the interested entity. The first profile including a first plurality of attributes, a first plurality of attribute values associated with each of the first plurality of attributes, and a first unique identifier associated with the first profile to identify the interested entity.

Further, the instructions 410, when executed, may cause the processor 402 to verify the onboarding of interested entity. To verify the onboarding of the interested entity, the instructions 410 may cause the processor 402 to execute pre-defined veracity test sequences associated with at least a subset of the first plurality of attributes of the first plurality of attribute values to verify the first profile. In an example, to execute one of the pre-defined veracity test sequences, the instructions 410, when executed, may cause the processor 402 to analyze historical data associated with the interested entity to provide a confidence score to an attribute of the subset of the first plurality of attributes. The attribute may be verified when the confidence score is above a pre-defined confidence score threshold value.

The instructions 410, when executed, may cause the processor 402 to store the first profile, in response to successfully verifying the interested entity, in an immutable form on a decentralized authentication framework. The instructions 410 may cause the processor 402 to store the first profile and link a first unique token repository to the first profile of the interested entity. The first unique token repository maintaining one or more tokens and each of the one or more tokens having assigned thereto a pre-defined token value.

In addition to the above-mentioned steps, the instructions 410, when executed, may cause the processor 402 to receive an engagement request, from at least one of the interested entity and the entity of interest, to initiate a profile engagement between the interested entity and the entity of interest. The entity of interest comprising a second profile associated thereto on the decentralized authentication framework. The second profile including a second plurality of attributes, a second plurality of attribute values associated with each of the second plurality of attributes, and a second unique identifier associated with the second profile to identify the entity of interest.

The instructions 410, when executed, may cause the processor 402 to authenticate the engagement request to determine a credibility of the engagement request. The engagement request may be authenticated by authenticating the at least one of the interested entity and the entity of interest. Upon successful authentication of the engagement request, the instructions 410, when executed, may cause the processor 402 to retrieve the first profile and the second profile from the decentralized authentication framework.

Further, the instructions 410, when executed, may cause the processor 402 to authenticate the engagement request to initiate engagement between the interested entity and the entity of interest. The initiating may comprise storing an indication of an association of the interested entity and the entity of interest in the decentralized authentication framework.

In an example, to initiate the engagement between the interested entity and the entity of interest, the instructions 410, when executed, may cause the processor 402 to establish, based on the approval, an association between at least a subset of the first plurality of attributes and a corresponding subset of the second plurality of attributes to create an engagement of the first profile and the second profile.

In another example, to initiate the engagement between the interested entity and the entity of interest, the instructions 410, when executed, may cause the processor 402 to transfer a pre-defined token value from the first unique token repository to a second unique token repository. The second unique token repository may be linked with the second profile and maintaining one or more tokens. Each of the one or more tokens having assigned thereto a pre-defined token value.

In yet another example, to initiate the engagement between the interested entity and the entity of interest, the instructions 410, when executed, may cause the processor 402 to execute a smart contract associated with the engagement between the first profile and the second profile. The smart contract may be hosted on the decentralized authentication framework.

Although examples of the present subject matter have been described in language specific to methods and/or structural features, it is to be understood that the present subject matter is not limited to the specific methods or features described. Rather, the methods and specific features are disclosed and explained as examples of the present subject matter.

In the foregoing specification, the present subject matter has been described with reference to specific embodiments thereof. It will, however, be evident that various modifications and changes may be made thereto without departing from the broader spirit and scope of the present subject matter. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. A system for entity engagement, the system comprising:
a processor to:
receive an onboarding request from an interested entity, the onboarding request being indicative of an intention to create an engagement with an entity of interest;
generate a first profile for the interested entity, the first profile including a first plurality of attributes, a first plurality of attribute values associated with each of the first plurality of attributes, and a first unique identifier associated with the first profile to identify the interested entity;
verify the onboarding of the interested entity to onboard the interested entity, wherein the processor is to execute pre-defined veracity test sequences associated with at least a subset of the first plurality of attributes of the first plurality of attribute values to verify the first profile;
store the first profile, in response to successfully verifying the interested entity, in an immutable form on a decentralized authentication framework, wherein the processor is to link a first unique token repository to the first profile of the interested entity, the first unique token repository maintaining one or more tokens and each of the one or more tokens having assigned thereto a pre-defined token value;
receive an engagement request, from at least one of the interested entity and the entity of interest, to initiate a profile engagement between the interested entity and the entity of interest, the entity of interest comprising a second profile associated thereto on the decentralized authentication framework, the second profile including a second plurality of attributes, a second plurality of attribute values associated with each of the second plurality of attributes, and a second unique identifier associated with the second profile to identify the entity of interest;
authenticate the engagement request to determine a credibility of the engagement request, the engagement request being authenticated by authenticating the at least one of the interested entity and the entity of interest;
retrieve, upon successful authentication of the engagement request, the first profile and the second profile from the decentralized authentication framework;
receive, from at least one of the interested entity and the entity of interest, an approval to initiate engagement between the interested entity and the entity of interest; and
initiate engagement between the interested entity and the entity of interest, wherein the processor is to store an indication of an association of the interested entity and the entity of interest in the decentralized authentication framework.

2. The system of claim 1, wherein to initiate engagement between the interested entity and the entity of interest, the processor is to:
establish, based on the approval, an association between at least a subset of the first plurality of attributes and a corresponding subset of the second plurality of attributes to create an engagement of the first profile and the second profile.

3. The system of claim 1, wherein to initiate engagement between the interested entity and the entity of interest, the processor is to:
transfer a pre-defined token value from the first unique token repository to a second unique token repository, the second unique token repository being linked with the second profile and maintaining one or more tokens, each of the one or more tokens having assigned thereto a pre-defined token value.

4. The system of claim 1, wherein to initiate engagement between the interested entity and the entity of interest, the processor is to:
execute a smart contract associated with the engagement between the first profile and the second profile, the smart contract being hosted on the decentralized authentication framework.

5. The system of claim 1, wherein the processor is to:
update a record of engagements for the at least one of the interested entity and the entity of interest, the record of engagements being associated with the at least one of the first unique identifier and the second unique identifier and the record of engagements including information regarding historical engagements of the at least one of the interested entity and the entity of interest.

6. The system of claim 1, wherein to execute pre-defined veracity test sequences, the processor is to:
analyze historical data associated with the interested entity to provide a confidence score to an attribute of the subset of the first plurality of attributes, the attribute being verified when the confidence score is above a pre-defined confidence score threshold value.

7. The system of claim 5, wherein the processor is to:
analyze the record of engagements to determine performance analytics for the engagement between the interested entity and the entity of interest.

8. A method for entity engagement, the method comprising:
receiving an onboarding request from an interested entity, the onboarding request being indicative of an intention to create an engagement with an entity of interest;
generating a first profile for the interested entity, the first profile including a first plurality of attributes, a first plurality of attribute values associated with each of the first plurality of attributes, and a first unique identifier associated with the first profile to identify the interested entity;
verifying the onboarding of interested entity by executing pre-defined veracity test sequences, the veracity test sequences being associated with at least a subset of the first plurality of attributes of the first plurality of attribute values;
storing the first profile, in response to successfully verifying the interested entity, in an immutable form on a decentralized authentication framework, wherein the storing the first profile comprises linking a first unique token repository to the first profile of the interested entity, the unique token repository maintaining one or more tokens and each of the one or more tokens having assigned thereto a pre-defined token value;
receiving an engagement request, from at least one of the interested entity and the entity of interest, to initiate a profile engagement between the interested entity and the entity of interest, the entity of interest comprising a second profile associated thereto on the decentralized authentication framework, the second profile including a second plurality of attributes, a second plurality of attribute values associated with each of the second plurality of attributes, and a second unique identifier associated with the second profile to identify the entity of interest;
authenticating the engagement request to determine a credibility of the engagement request, the engagement request being authenticated by authenticating the at least one of the interested entity and the entity of interest;
retrieving, upon successful authentication of the engagement request, the first profile and the second profile from the decentralized authentication framework;
receiving, from at least one of the interested entity and the entity of interest, an approval to initiate engagement between the interested entity and the entity of interest; and
initiating engagement between the interested entity and the entity of interest, wherein the initiating comprises storing an indication of an association of the interested entity and the entity of interest in the decentralized authentication framework.

9. The method of claim 8, wherein initiating engagement between the interested entity and the entity of interest comprises:
establishing, based on the approval, an association between at least a subset of the first plurality of attributes and a corresponding subset of the second plurality of attributes to create an engagement of the first profile and the second profile.

10. The method of claim 8, wherein initiating engagement between the interested entity and the entity of interest comprises:
transferring a pre-defined token value from the first unique token repository to a second unique token repository, the second unique token repository being linked with the second profile and maintaining one or more tokens, each of the one or more tokens having assigned thereto a pre-defined token value.

11. The method of claim 8, wherein initiating engagement between the interested entity and the entity of interest comprises:
executing a smart contract associated with the engagement between the first profile and the second profile, the smart contract being hosted on the decentralized authentication framework.

12. The method of claim 8, further comprising:
updating a record of engagements for the at least one of the interested entity and the entity of interest, the record of engagements being associated with the at least one of the first unique identifier and the second unique identifier and the record of engagements including information regarding historical engagements of the at least one of the interested entity and the entity of interest.

13. The method of claim 8, wherein executing the pre-defined veracity test sequences, comprises:
analyzing historical data associated with the interested entity to provide a confidence score to an attribute of the subset of the first plurality of attributes, the attribute being verified when the confidence score is above a pre-defined confidence score threshold value.

14. The method of claim 12, further comprising:
analyzing the record of engagements to determine performance analytics for the engagement between the interested entity and the entity of interest.

15. A non-transitory computer-accessible storage medium storing program comprising instructions for entity engagement, the instructions being executable by a processor to:
receive an onboarding request from an interested entity, the onboarding request being indicative of an intention to create an engagement with an entity of interest;
generate a first profile for the interested entity, the first profile including a first plurality of attributes, a first plurality of attribute values associated with each of the first plurality of attributes, and a first unique identifier associated with the first profile to identify the interested entity;
verify the onboarding of interested entity, wherein the instructions being executable to execute pre-defined veracity test sequences associated with at least a subset of the first plurality of attributes of the first plurality of attribute values to verify the first profile; and
store the first profile, in response to successfully verifying the interested entity, in an immutable form on a decentralized authentication framework, wherein the instructions being executable by the processor to link a first unique token repository to the first profile of the interested entity, the first unique token repository maintaining one or more tokens and each of the one or more tokens having assigned thereto a pre-defined token value.

16. The non-transitory computer-accessible storage medium of claim 15, wherein the instructions being executable by a processor to:
receive an engagement request, from at least one of the interested entity and the entity of interest, to initiate a profile engagement between the interested entity and the entity of interest, the entity of interest comprising a second profile associated thereto on the decentralized authentication framework, the second profile including a second plurality of attributes, a second plurality of attribute values associated with each of the second plurality of attributes, and a second unique identifier associated with the second profile to identify the entity of interest;
authenticate the engagement request to determine a credibility of the engagement request, the engagement request being authenticated by authenticating the at least one of the interested entity and the entity of interest;
retrieve, upon successful authentication of the engagement request, the first profile and the second profile from the decentralized authentication framework;
receive, from at least one of the interested entity and the entity of interest, an approval to initiate engagement between the interested entity and the entity of interest; and
initiate engagement between the interested entity and the entity of interest, the initiating comprises storing an indication of an association of the interested entity and the entity of interest in the decentralized authentication framework.

17. The non-transitory computer-accessible storage medium of claim 16, wherein to initiate the engagement between the interested entity and the entity of interest, the instructions being executable by a processor to:
establish, based on the approval, an association between at least a subset of the first plurality of attributes and a corresponding subset of the second plurality of attributes to create an engagement of the first profile and the second profile.

18. The non-transitory computer-accessible storage medium of claim 16, wherein to initiate the engagement between the interested entity and the entity of interest, the instructions being executable by a processor to:
transfer a pre-defined token value from the first unique token repository to a second unique token repository, the second unique token repository being linked with the second profile and maintaining one or more tokens, each of the one or more tokens having assigned thereto a pre-defined token value.

19. The non-transitory computer-accessible storage medium of claim 16, wherein to initiate the engagement of the first profile and the second profile, the instructions being executable by a processor to:
execute a smart contract associated with the engagement between the first profile and the second profile, the smart contract being hosted on the decentralized authentication framework.

20. The non-transitory computer-accessible storage medium of claim 16, wherein to execute one of the pre-defined veracity test sequences, the instructions being executable by a processor to:
analyze historical data associated with the interested entity to provide a confidence score to an attribute of the subset of the first plurality of attributes, the attribute being verified when the confidence score is above a pre-defined confidence score threshold value.
